(19) United States
(12) Patent Application Publication
(10) Pub. No.: US 2026/0025591 A1
(43) Pub. Date: Jan. 22, 2026

(54) METHOD FOR CONTROLLING ILLUMINATION INTENSITY OF A SCENE MONITORED BY A CAMERA AND MONITORING DEVICE

(71) Applicant: Robert Bosch GmbH, Stuttgart (DE)

(72) Inventors: Fernando Silvestre, Eindhoven (NL); Masami Haino, Eindhoven (NL)

(21) Appl. No.: 19/145,150

(22) PCT Filed: Jan. 19, 2023
(86) PCT No.: PCT/EP2023/051211

§ 371 Date: Jul. 1, 2025

(51) Int. Cl. H04N 23/74; H04N 23/71

(52) U.S. Cl. CPC H04N 23/74; H04N 23/71

(57) ABSTRACT

The present invention relates to a method for controlling illumination intensity of a scene monitored by a camera, comprising determining (101) a brightness distribution of an image of the scene captured with the camera, determining (103, 104, 106) a brightness distribution spread and classifying (112, 115) the brightness distribution spread into at least a narrow class, a normal class and a wide class. If the brightness distribution spread is in the narrow class, illumination intensity is increased. If the brightness distribution spread is in the normal class, illumination intensity is kept at the current level. If the brightness distribution spread is in the wide class, controlling (117, 118, 119) illumination intensity depending on a number of bright objects in the image.

### FIELD OF THE INVENTION

The present invention relates to a method for controlling illumination intensity of a scene monitored by a camera, a monitoring device, a computer program and a computer-readable medium.

### BACKGROUND OF THE INVENTION

Security cameras uses illuminating devices which irradiate the light such as infra-red rays and visible light, in order to monitor distant objects and improve image quality in low light environments such as at night. In this case, objects close to the camera are strongly illuminated by the light of the illuminating device, so that objects close to the camera are oversaturated in the image.

DE 10 2015 218 376 A1 proposes a monitoring device with a first camera device, the first camera device being designed to capture images of a surveillance area in an infrared wavelength range and to output first image data, with a second camera device, the second camera device being designed for image capture in the surveillance area in a VIS wavelength range and for outputting second image data, with an illumination device for illumination of the surveillance area for the second camera device, and with a control device, the control device comprising a control module for controlling the illumination device and the second camera device, so that the second camera device captures the monitored area illuminated by the illumination device and outputs it as illuminated second image data. The control device has a detection module for detection of a moving and/or thermal object in the first image data, with the detection module being designed to automatically trigger the control module upon detection of the object in the first image data and/or to offer a user manual triggering of the control module, so that illuminated, second image data are recorded.

### SUMMARY

According to the invention, a method for controlling illumination intensity of a scene monitored by a camera, a monitoring device, a computer program and a computer-readable medium with the features of the independent claims are proposed. Advantageous further developments form the subject matter of the dependent claims and of the subsequent description.

In view of the prior art, the present invention advantageously provides a control method for optimizing the illumination intensity according to the brightness of objects in a scene monitored by a camera. In particular, the method for controlling illumination intensity of a scene monitored by a camera comprises capturing an image of the scene with the camera, determining a brightness distribution of the image, determining a brightness distribution spread and classifying the brightness distribution spread into at least three classes, the at least three classes comprising a narrow class, a normal class and a wide class.

If the brightness distribution spread is in the narrow class, the illumination intensity is increased, e.g. by increasing the power to the illuminating device. The method could end here.

However, if the brightness distribution spread is in the normal class, the illumination intensity is kept at the current level. The method could end here.

However, if the brightness distribution spread is in the wide class, the illumination intensity is controlled depending on a number of bright objects in the image. It should be noted that even if the method could end before, if the brightness distribution spread is in the narrow or normal class, it is understood by the skilled person that depending on the specific implementation of the invention e.g. in a computing unit, the number of bright objects in the image can be determined in any case, even if the brightness distribution spread is in the narrow or normal class.

So, without object detection and object classification, the invention reduces the illumination intensity and thus avoids saturation when there is a bright object in the image.

According to an embodiment, if no bright objects are present, the illumination intensity is increased. The method could end here. If, however, at least one bright object is present, an average brightness value of the at least one bright object is calculated, and the illumination intensity is controlled depending on the average brightness value. Thus, the illumination control can be based on easily determinable values in an image.

According to an embodiment, if the average brightness value of the at least one bright object is below a brightness threshold value, the illumination intensity is kept at the current level. The brightness threshold value can be predefined e.g. based on the type of the camera. If the average brightness value of the at least one bright object is above the brightness threshold value, the illumination intensity is decreased. Thus, the illumination control can be based on a simple two-way-decision.

According to an embodiment, controlling the illumination intensity depending on the number of bright objects in the image comprises determining a bright object threshold value of the image from the brightness distribution. Then, a number of bright objects in the image is determined based on the bright object threshold value. This is an easily implementable way for determining the number.

According to an embodiment, the classifying the brightness distribution spread into at least three classes comprises comparing the brightness distribution spread with class threshold values. E.g. if the brightness distribution spread is at most 25% of the distribution width (e.g. 8 of 32), the brightness distribution spread can be classified as narrow. E.g. if the brightness distribution spread is at least 35% of the distribution width (e.g. 12 of 32), the brightness distribution spread can be classified as wide. Otherwise (e.g. 9 to 11) as normal. By this, a simple way of classification that can be easily implemented is provided.

According to an embodiment, a brightness histogram is determined as the brightness distribution, and a brightness histogram spread is determined as the brightness distribution spread. As it is known in prior art, a histogram is an approximate representation of the distribution of numerical data, wherein the entire range of intensity values is divided into a series of intervals—so called “bins”—and the number of values (here image units, e.g. pixels) in each interval is counted. The bins are usually specified as consecutive, non-overlapping intervals of a variable (here brightness).

According to an embodiment, the determining the brightness histogram spread comprises determining a first histogram bin value characterized by a brightness that at most a first portion of all image units have, determining a second histogram bin value characterized by a brightness that at most a second portion of all image units have, and calculating a difference value between the first and the second histogram bin values. In particular, the second portion is larger than the first portion, and includes the first portion. In exemplary words, the first histogram bin value can be characterized by the x % darkest image units, and the second histogram bin value can be characterized by the y % darkest image units, with x<y. By this, a simple way of determining the brightness histogram spread that can be easily implemented is provided.

In an embodiment, the first histogram bin value and the second histogram bin value are determined in the cumulative brightness histogram, as there the first and second portion can be easily identified. The first histogram bin value can be defined as the number of bins in the cumulative histogram at which a specific low threshold value (“black value”) is reached, where the low threshold value may correspond to 0.5-25% of the number x of image units in the image, preferably 5%. The second histogram bin value can be defined as the number of bins in the cumulative histogram at which a specific high threshold value (“white value”) is reached, where the high threshold value may correspond to 75-99.5% of the number y of image units, preferably 95%. By this, a simple way of determining the brightness histogram spread that can be easily implemented is provided.

According to an embodiment, the brightness histogram is normalized into a predetermined number of histogram bins. The number of bins in the histogram can be between 8 and 128, or between 16 and 64, or 32. For example, for a histogram with total bin number of 32, bin number 1 is normalised to 3.1% brightness and bin number 32 to 100% brightness. By this, the histogram generation and the spread classification can be easily implemented.

According to an embodiment, the determining a number of bright objects in the image based on the bright object threshold value comprises dividing the image into a predetermined number of tiles (or blocks), determining a brightness value of each of the predetermined number of tiles, comparing the brightness value of each of the predetermined number of tiles with the bright object threshold value, wherein each separated array of one or more connected tiles whose brightness value is higher than the bright object threshold value forms one object. By this, a simple way of counting bright objects that can be easily implemented is provided. Also, the use of bright block detection instead of object detection reduces the amount of memory and calculation required and the time required for control.

According to an embodiment, each separated array of at least X connected tiles whose brightness value is higher than the bright object threshold value forms one object, X being an integer larger than 1. X can e.g. be 4, i.e. in this example tile arrays having less than 4 tiles are not counted as objects. By this, bright but small areas that may likely be artefacts in the image may be ignored.

According to an embodiment, the bright object threshold value is determined depending on the most frequent brightness in the image. In particular, the bright object threshold value is further determined depending on the size of the histogram bin representing the most frequent brightness in the image. In an embodiment, the bright object threshold value is determined as the brightness of the histogram bin having the lowest brightness of all histogram bins with a higher brightness than the most frequent brightness, and having a size lower than the size of the histogram bin representing the most frequent brightness in the image, multiplied by a predefined ratio (or factor). The predefined ratio may be between 2% and 20%, e.g. 5%. By this, bright objects can be certainly identified.

A monitoring device according to the invention has a camera and an illuminating device and means adapted to execute the steps of any inventive method.

The implementation of a method according to the invention in the form of a computer program or computer program product with program code for carrying out all method steps is advantageous because this causes particularly low costs, especially if an executing control unit is also used for other tasks and is therefore available anyway. Finally, a machine-readable storage medium is provided with a computer program stored thereon as described above. Suitable storage media or data carriers for providing the computer program are, in particular, magnetic, optical and electrical storage devices such as hard drives, flash memories, EEPROMs, DVDs, etc. It is also possible to download a program via computer networks (Internet, intranet, etc.). Such a download can be wired or wired or wireless (e.g. via a WLAN network, a 3G, 4G, 5G or 6G connection, etc.).

Further advantages and embodiments of the invention result from the description and the enclosed drawings.

The invention is shown schematically in the drawing using exemplary embodiments and is described below with reference to the drawings.

### BRIEF DESCRIPTION OF THE DRAWINGS

FIG. 1 shows a block diagram of an embodiment of a method according to the invention.

FIG. 2 shows a block diagram of an embodiment of a monitoring device according to the invention.

FIG. 3 shows a block diagram of an embodiment of a monitoring device according to the invention.

FIG. 4 shows a block diagram of an embodiment of a computing unit according to the invention.

FIG. 5 schematically shows a number of tiles in a captured image that can be used by an embodiment of a method according to the invention.

FIG. 6 schematically shows intensity values in the number of tiles of FIG. 5.

FIG. 7 shows a brightness histogram of the image of FIG. 6.

FIG. 8 shows the cumulative brightness histogram of FIG. 7, and threshold values for calculating a histogram spread.

FIG. 9 shows a captured image with low brightness that can be used by an embodiment of a method according to the invention.

FIG. 10 shows a brightness histogram of the image of FIG. 9.

FIG. 11 shows the cumulative brightness histogram of FIG. 10, and threshold values for calculating a histogram spread.

FIG. 12 shows another brightness histogram, and threshold values for calculating a bright object threshold.

FIG. 13 shows tiles separated by the bright object threshold value.

FIG. 14 shows a determination of tile sizes of bright objects in the image of FIG. 13.

FIG. 15 shows the use of only objects with a minimum tile size of four tiles.

### EMBODIMENT(S) OF THE INVENTION

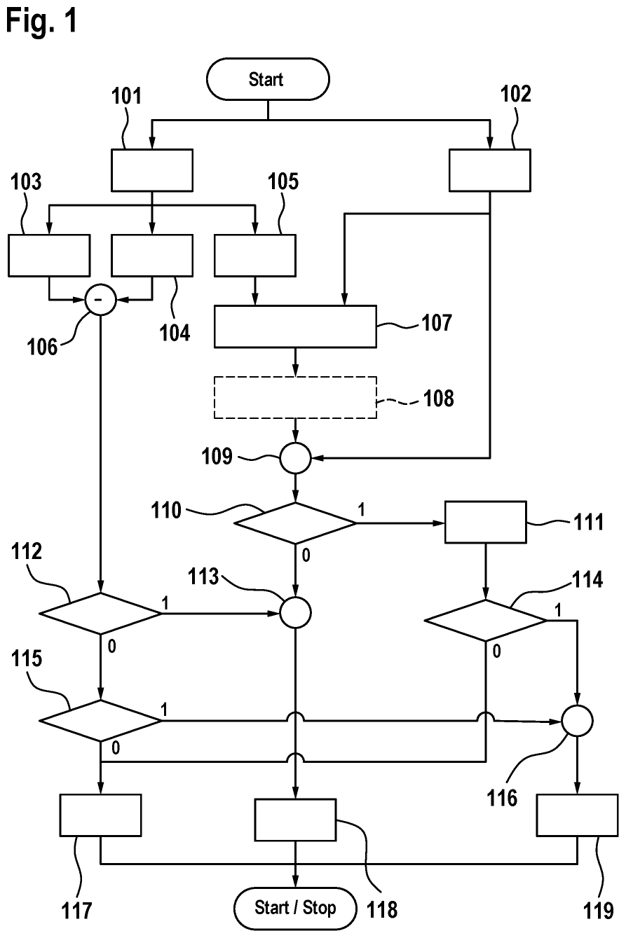

In the following, exemplary embodiments of the invention are described with reference to FIGS. 1 to 15.

Referring to FIG. 1, a block diagram of an embodiment of a method according to the invention is shown and will be described in the following.

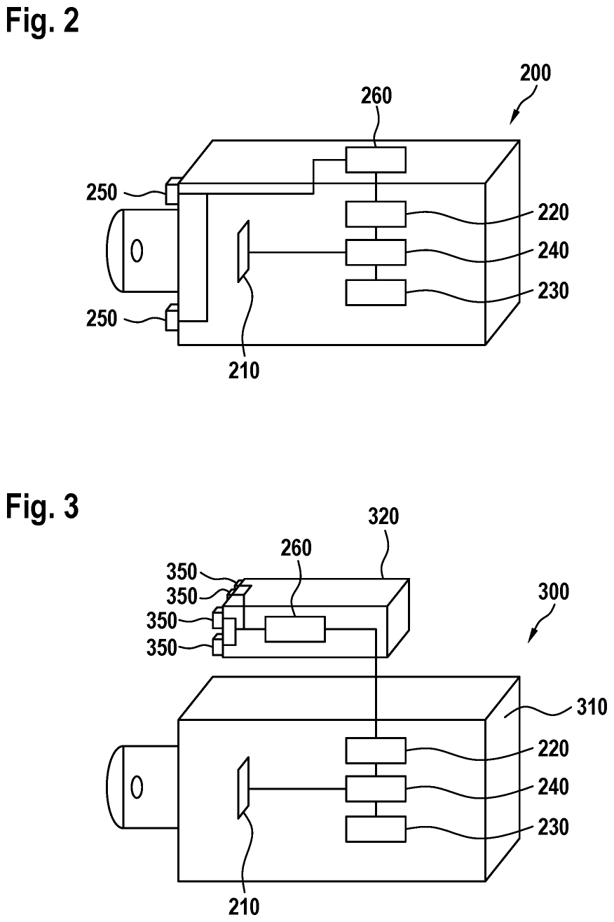

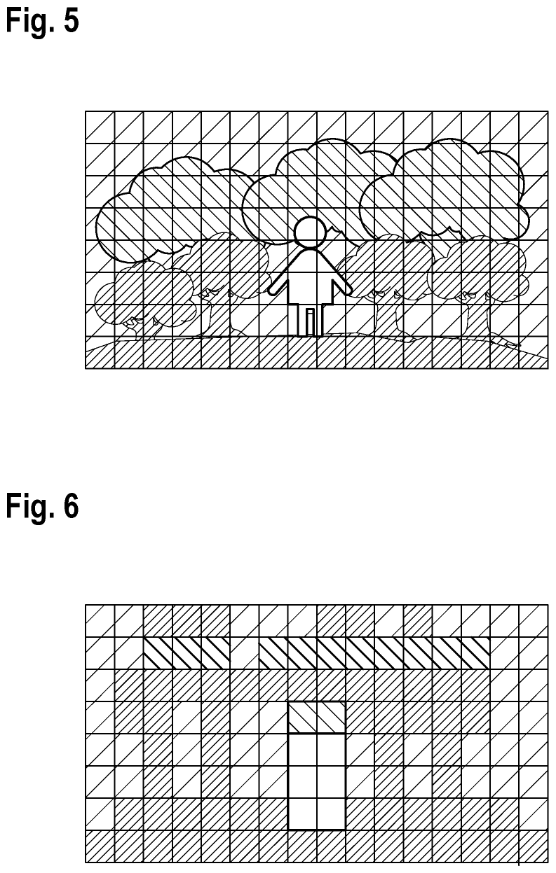

In step 101, a brightness histogram of an image (cf. FIG. 5, 9) of the scene captured with a camera (cf. FIG. 2, 3) is determined as embodiment for a brightness distribution. It is to be noted that other embodiments, in particular other frequency distributions, can be used.

In step 102, the image is divided into a predetermined number of tiles or blocks (cf. FIG. 5).

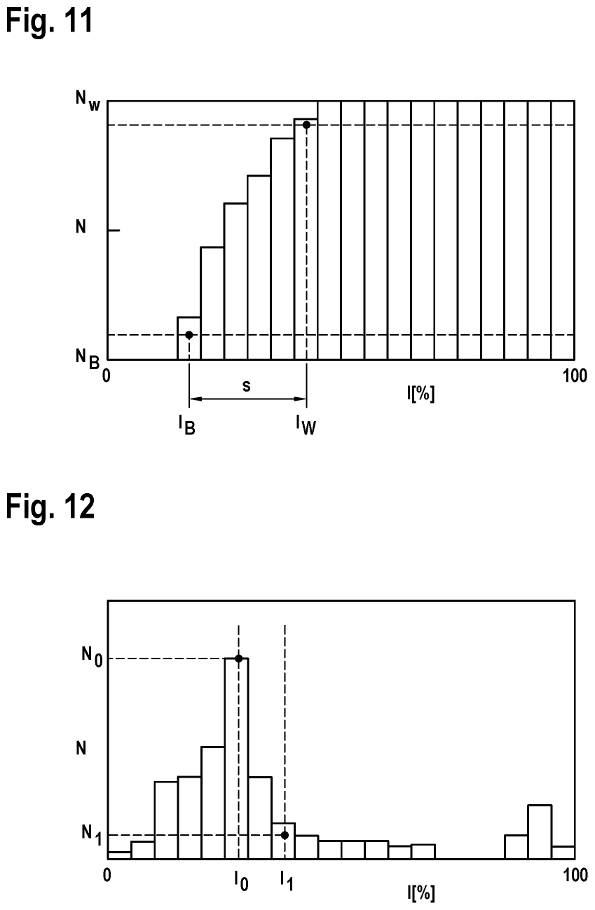

In steps 103, 104, and 106 a brightness histogram spread S is determined (cf. FIGS. 8, 11) as a distribution spread. Especially, in step 103 a first histogram bin value I_{B} is determined. The first histogram bin value I_{B} is characterized by a (low) brightness that at most a first portion N_{B} of all image units (e.g. pixels) have. In step 104 a second histogram bin value I_{W} is determined. The second histogram bin value I_{W} is characterized by a (high) brightness that at most a second portion N_{W} of all image units have. It is clear that the second portion is bigger than the first portion, and includes the first portion, as the image units that have at most the low brightness have at most the high brightness, too. In step 106 a difference value S between the second and the first histogram bin values I_{W}−I_{B} is calculated.

In steps 112 and 115, the brightness histogram spread S is classified into three classes, comprising a narrow class, a normal class and a wide class. Especially, in step 112, the brightness histogram spread S is compared with a low class threshold value (HistogramLimits1). If the brightness histogram spread is lower than the low class threshold value, connection “1”, the brightness histogram spread can be classified as narrow, and it is proceeded with step 113.

Step 113 is an “OR”-connection, which means that in case the brightness histogram spread can be classified as narrow, the method always proceeds with step 118. In this case, it is determined that the intensity of the illuminating device is low and the area being captured is not sufficiently illuminated.

In step 118, the illuminating intensity is increased.

In step 115, the brightness histogram spread S is compared with a high class threshold value (HistogramLimits2). If the brightness histogram spread is higher than the high class threshold value, connection “1”, the brightness histogram spread can be classified as wide, and it is proceeded with step 116.

Otherwise, connections “0” in 112 and 115, the brightness histogram spread can be classified as normal, and it is proceeded with step 117.

In step 117, the illuminating device intensity is determined to be optimal for illuminating the scene, and the illuminating intensity is not changed.

In step 105, a bright object threshold value (cf. 11 in FIG. 12) of the image is determined from the brightness histogram.

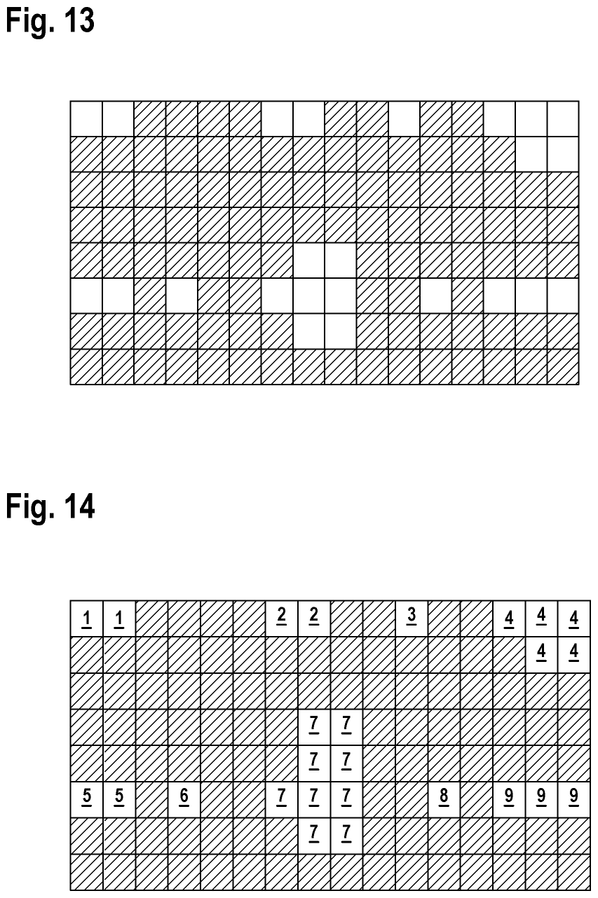

In step 107, the tiles having an intensity value above the bright object threshold are determined (cf. FIG. 13).

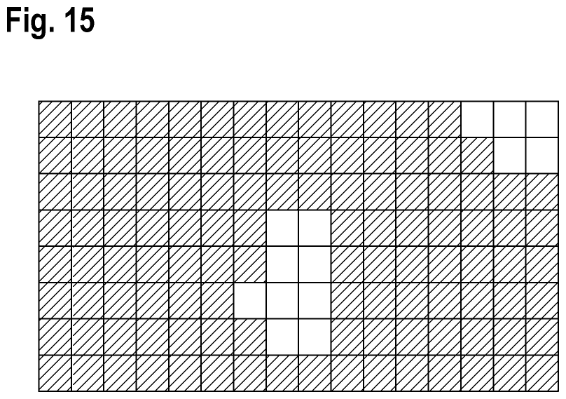

In step 108, the separated arrays having a specific minimum size of connected tiles whose brightness value is higher than the bright object threshold is determined. The minimum size can be one tile, or can be more than one tile, e.g. four tiles (cf. FIGS. 14 and 15).

In step 109 the tiles that do not contribute to the bright objects are ignored or masked out.

In step 110, a number of bright objects in the image is determined based on the bright object threshold value.

If no bright object is present, connection “0”, it is proceeded with step 113, and then 118 (see above), i.e. illumination intensity is increased.

If at least one bright object is present, connection “1”, an average brightness value of the bright objects is calculated in step 111.

In step 114, the average brightness value of the at least one bright object is compared with a brightness threshold value. This value can be e.g. pre-set based on the specific camera, sensor, and/or illumination device. This mechanism can be used to avoid reducing the intensity of the illuminating device when the calculated average brightness value is small, i.e. there is no need to reduce the intensity of illumination. It can be defined as a percentage of the signal range of the image units in the input image, and should be set to at least 20%, preferably 25-35%.

If the average brightness value of the at least one bright object is below the brightness threshold value, connection “0”, it is proceeded with step 117 (see above), i.e. the illumination intensity is kept at the current level.

If the average brightness value of the at least one bright object is above the brightness threshold value, it is proceeded with step 119.

In step 119, the illuminating intensity is decreased.

A first embodiment of a monitoring device implementing the invention is a device 200 containing an image sensor 210, an illuminating device driver 220, a processor 230, a memory 240 and an illuminating device containing one or more light sources 250 (including one or more light sources emitting light in the sensitivity range of the image sensor, often infrared or visible light) as shown in FIG. 2.

A second embodiment of monitoring device implementing the invention is a device 300 in which camera 310 and illuminating device 320 can be separated and comprises the camera 310 including the image sensor 210, illuminating device driver 220, processor 230, memory 240 and interface with the illuminating device 320. The illuminating device 320 includes one or more light sources 350 (an illuminating device that emits light in the sensitivity range of the image sensor, often infra-red, or visible light) as shown in FIG. 3.

The illuminating device contains one or more light sources 250, 350 emitting light in the sensitivity range of the image sensor 210, often infrared or visible light, and is connected to an illuminating device's power supply 260. The light intensity of the illuminating device's light sources varies according to the amount of power supplied by the illuminating device's power supply 260. The amount of power for each light source can be increased or decreased individually. The illuminating device's power supply 260 is connected to the illuminating device driver 220, which controls the power of the camera's illuminating device 260.

The illuminating device contains at least one light source and the illuminating device can illuminate the monitored area of the camera. If the illuminating device has multiple light sources, it is also feasible that each light source can illuminate a different surveillance area. The invention can also be implemented if each light source of the illuminating device is of a different wavelength.

The illuminating device can be installed on the camera body, as shown in FIG. 2, or separately from the illuminating device camera, as shown in FIG. 3.

The camera may obtain the captured images from the image sensor, store them in the camera's internal memory, process the images in the processor and output the images (e.g. compressed video such as MP4 or AVI, compressed still images such as JPEG, uncompressed still images such as RAW, uncompressed video images).

The invention can be implemented as software (SW), firmware (FW), application stored in memory and executed via a control circuit such as a processor. Alternatively, the invention can be implemented as a hardware (HW) implementation as a circuit, or a combination of several of software, firmware, application, memory, hardware and processor.

The function of the Illuminating device's driver, which controls the power supply of the illuminating device, can be implemented in memory as FW, SW or application and executed via a control circuit such as a processor. This function can be implemented and executed in hardware as a dedicated circuit. Alternatively, it can be implemented in a combination of software, FW, memory, HW and processor. This can be done in combination with some of the following.

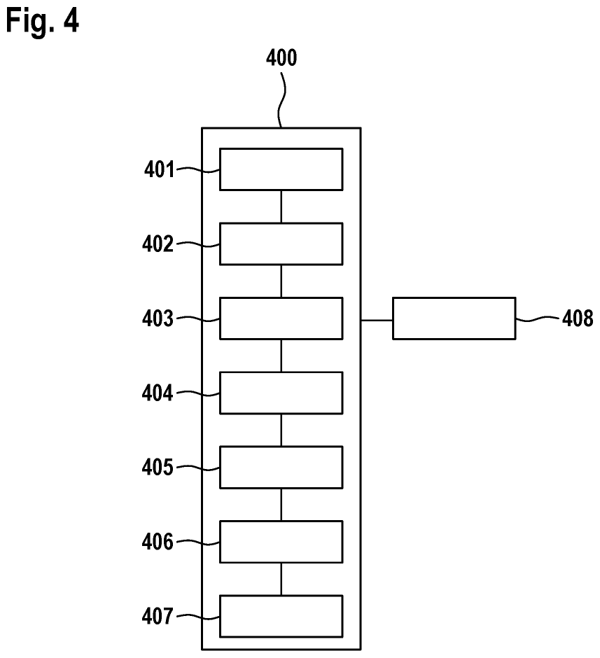

FIG. 4 shows an embodiment of the invention implemented by combining a memory 400 and a processor 408. In the memory, an embodiment of the invention is implemented by different modules 401 to 406, comprising a tile generator module 401, a histogram generator module 402, a module 403 for determining a brightness histogram spread, a module 404 for classifying the brightness histogram spread, a module 405 for determining a bright object threshold value of the image from the brightness histogram, a module 406 for determining a number of bright objects in the image based on the bright object threshold value, and a module 407 for controlling the illuminating device driver 220.

Tile generator module 401 is configured to divide the image into tiled blocks and calculates the intensity average value of each block (cf. FIG. 6).

The image as shown in FIG. 5 captured by the image sensor 210 is stored in memory 240, 400. As shown in FIG. 6, the image can be divided into a different number of vertical and horizontal segments, each number can arbitrarily be selected out of e.g. 8, 16, 32, 64, 128, 256, 512 etc. The average intensity value of each of the blocks is calculated. If the image sensor has colour filters, the average value of the image units of each colour can be calculated.

The input image to the tile generator module can be an image obtained from the image sensor, an image output during image processing such as blackout, noise reduction and colour correction, or an image for which image processing has been completed.

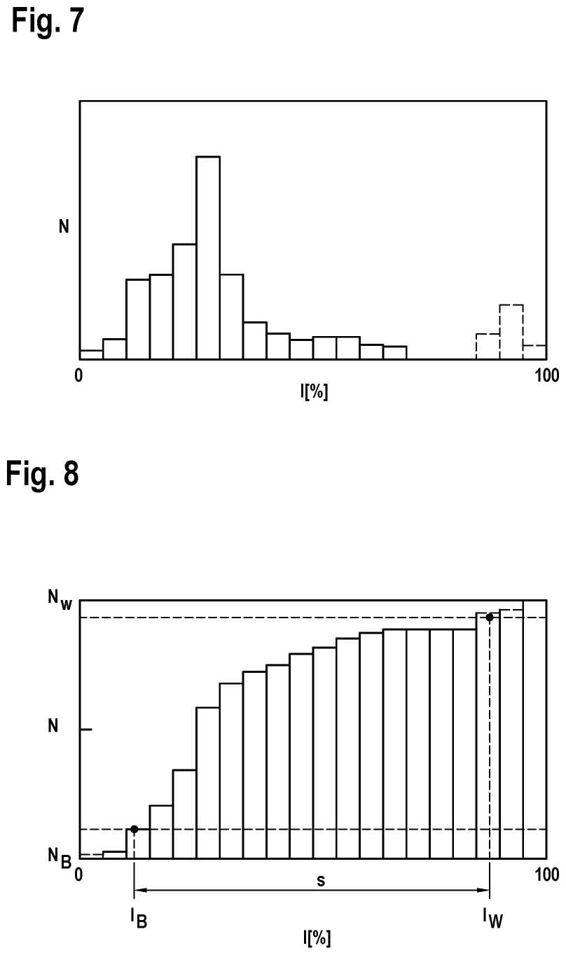

Histogram generator module 402 creates a brightness histogram (cf. FIG. 7) from the image or the output of tile generator module 401. The number of brightness bins in the histogram is e.g. between 10 and 128. To normalize the spread of the histogram, the bin number of the histogram can be expressed as a normalised representation. For example, for a histogram with total bin number of 32, bin number 1 is normalised to 3.1% and bin number 32 to 100% of the measurable brightness I. In each bin the number N of measured brightness is counted.

FIG. 7 shows a histogram and FIG. 8 shows a cumulative histogram of FIG. 5, when a subject close to the camera is saturated by the illuminating device light.

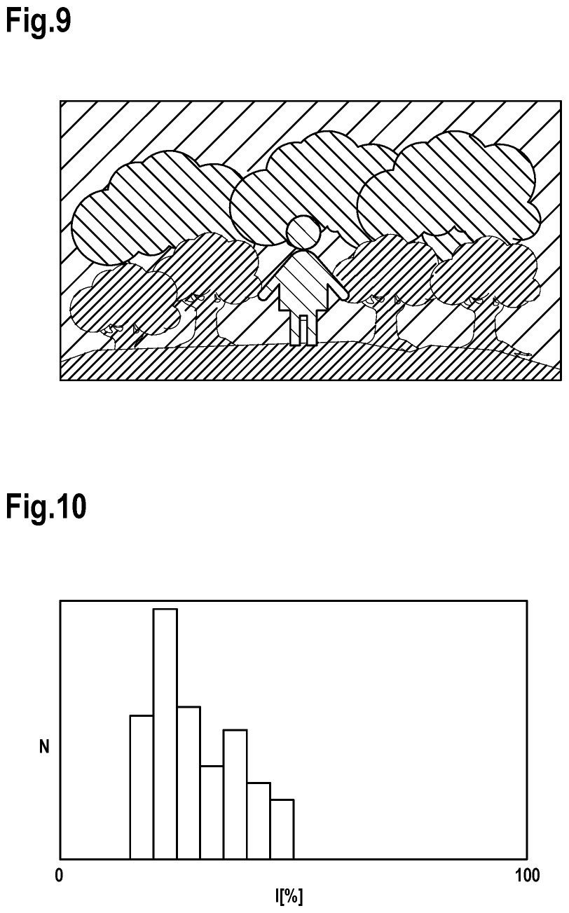

FIG. 9 shows an example of an image, when the subject close to the camera is not sufficiently illuminated by the illuminating device. FIG. 10 shows a histogram and FIG. 11 shows a cumulative histogram of FIG. 9.

The steps performed in the module 403 for determining a brightness histogram spread and the module 404 for classifying the brightness histogram spread are explained in the following with reference to FIGS. 1, and 7 to 11.

The histogram spread is indicated by the difference S between the bin numbers of the light and dark areas of the histogram. This value of the histogram indicates the degree of shrinkage, with smaller values indicating less contrast on the screen. To calculate the spread of the histogram, the output values of the histogram generator module 402 are accumulated to obtain a cumulative histogram, as shown in FIGS. 8 and 11. The histogram accumulation is shown as the number of bins on the horizontal axis and the number N of image units on the screen as a percentage on the vertical axis. The minimum value on the vertical axis is 0 and the maximum value is 100.

The dark part of the histogram is defined using a low (or “black”) threshold value N_{B}. A first histogram bin value I_{B} is the number of bins in the cumulative histogram at which the threshold value “Black” N_{B} is reached, where “Black” may correspond to 0.5-25% of the image units in the image, preferably 5%.

The bright part of the histogram is defined using a high (or “white”) threshold value N_{W}. A second histogram bin value I_{W} is the number of bins in the cumulative histogram at which the threshold value “White” N_{W} is reached, where “White” may correspond to 75-99.5% of the image units in the image, preferably 95%.

Histogram spread S is calculated as the difference between second histogram bin value I_{W} and first histogram bin value I_{B}, and this value indicates the spread of the histogram. If the distribution of the histogram is image-wide, as in FIG. 7, this value is large. If the distribution of the histogram is local, as in FIG. 10, this value is smaller. This description gives an example of classifying the state of the histogram into three classes: narrow, wide and normal. Furthermore, the histogram spread classification can be set to be more detailed and to determine three or more classes; the more classes are implemented, the finer intensity change conditions of the illuminating device can be controlled.

Step 107 and the module 405 for determining the bright object threshold value of the image from the brightness histogram are now explained with reference to FIG. 8. For defining the bright areas of an image, a histogram as shown in FIG. 8 generated by the histogram generator module 402 can be used.

First, the size (i.e. number of image units) of the bin with the most frequent brightness in the image is determined from the histogram as No and its brightness as I₀. Objects oversaturated by the illuminating device are above this brightness, and the bright/saturated objects are estimated to cover a (much) smaller area of the image than the objects with dominant brightness. Based on this estimation, a bin is determined to represent bright objects if the bin represents a higher brightness than I₀, and if the size N₁ (i.e. number of image units) of the bin is at most the product of N₀ and a predefined ratio. The predefined ratio may be between 2% and 20%, e.g. 5%. The brightness of the bin having the lowest brightness of all bright areas determined as above is defined as the bright object threshold value I₁.

In step 110 or with module 406 for determining a number of bright objects in the image based on the bright object threshold value, each tile calculated by the tile generator module 401 is judged whether it is above the bright object threshold value I₁. A result in form of binarized tiles is shown in FIG. 13, where areas with intensities above bright object threshold value I₁ are shown in white and areas with intensities below bright object threshold value I₁ are shown in black.

In FIG. 14, each separated array of one or more connected tiles whose brightness value is higher than the bright object threshold value I₁ forms an object. In FIG. 10, these objects are labelled or numbered, respectively, to determine how many objects on the screen are above the bright object threshold value.

According to an embodiment, each separated array of at least X connected tiles whose brightness value is higher than the bright object threshold value forms one object, X being an integer larger than 1, e.g. 4 in FIG. 15. If the labelled bright area is smaller than this (arbitrary) size, the area is determined to be an area with locally bright objects such as light sources, and is excluded from the bright area in step 108.

The white tiles of FIG. 15 obtained after such a process show the estimated saturated area, which is determined to be an area over-illuminated by the illuminating device. A binarized version of this is applied to the tiles as a filter in step 109, and the average brightness value of the estimated saturated areas is calculated in step 111.

In step 116 the cases where the histogram spread is classified as wide and the average brightness value of the at least one bright object is above the brightness threshold value are combined. In this case, the estimated saturated area is judged to be excessively illuminated by the illuminating device.

1. A method for controlling illumination intensity of a scene monitored by a camera, the method comprising:
determining (101, 402), via a computer, a brightness distribution of an image of the scene captured with the camera,
determining (103, 104, 106; 403), via the computer, a brightness distribution spread (S) and classifying (112, 115; 404) the brightness distribution spread (S) into at least three classes, the at least three classes comprising a narrow class, a normal class, and a wide class, and
when the brightness distribution spread (S) is in the narrow class, increasing (118) illumination intensity,
when the brightness distribution spread (S) is in the normal class, keeping (117) illumination intensity at the current level, and
when the brightness distribution spread (S) is in the wide class, controlling (117, 118, 119) illumination intensity depending on a number of bright objects in the image.

2. The method of claim 1, wherein the controlling (117, 118, 119) the illumination intensity depending on the number of bright objects in the image comprises:
if no bright objects are present, increasing (118) illumination intensity,
if at least one bright object is present, calculating (111) an average brightness value of the at least one bright object, and controlling the illumination intensity depending on the average brightness value.

3. The method of claim 2, wherein the controlling the illumination intensity depending on the average brightness value comprises:
if the average brightness value of the at least one bright object is below a brightness threshold value, keeping (117) illumination intensity at the current level,
if the average brightness value of the at least one bright object is above the brightness threshold value, decreasing (119) illumination intensity.

4. The method of claim 1, wherein the controlling (117, 118, 119) the illumination intensity depending on the number of bright objects in the image comprises:
determining (105, 405) a bright object threshold value (I1) of the image from the brightness distribution,
determining (110, 406) the number of bright objects in the image based on the bright object threshold value (I1).

5. The method of claim 4, wherein the determining (110, 406) the number of bright objects in the image based on the bright object threshold value (I1) comprises dividing (102) the image into a predetermined number of tiles, determining a brightness value of each of the predetermined number of tiles, comparing (107) the brightness value of each of the predetermined number of tiles with the bright object threshold value (I1), wherein each separated array of one or more connected tiles whose brightness value is higher than the bright object threshold value forms (108) one object.

6. The method of claim 5, wherein each separated array of at least X connected tiles whose brightness value is higher than the bright object threshold value forms (108) one object, X being an integer larger than one.

7. The method of claim 4, further comprising determining the bright object threshold value (I1) depending on the most frequent brightness (I0) in the image.

8. The method of claim 1, wherein the classifying the brightness distribution spread (S) into at least three classes comprises comparing (112, 115) the brightness distribution spread (S) with class threshold values.

9. The method of claim 1, wherein the determining (101, 402) the brightness distribution of the image of the scene captured with the camera comprises determining (101, 402) a brightness histogram of the image of the scene captured with the camera, and the determining the brightness distribution spread (S) comprises determining a brightness histogram spread (S).

10. The method of claim 9, wherein the determining the brightness histogram spread (S) comprises determining (103) a first histogram bin value (IB) characterized by a brightness that at most a first portion (NB) of all image units have, determining (104) a second histogram bin value (IW) characterized by a brightness that at most a second portion (NW) of all image units have, and calculating (106) a difference value between the second and the first histogram bin values.

11. The method of claim 10, wherein the brightness histogram is normalized into a predetermined number of histogram bins.

12. A method of for controlling illumination intensity of a scene monitored by a camera, the method comprising:
determining (101, 402), via a computer, a brightness distribution of an image of the scene captured with the camera,
determining (103, 104, 106; 403), via the computer, a brightness distribution spread (S) and classifying (112, 115; 404) the brightness distribution spread (S) into at least three classes, the at least three classes comprising a narrow class, a normal class, and a wide class, and
when the brightness distribution spread (S) is in the narrow class, increasing (118) illumination intensity,
when the brightness distribution spread (S) is in the normal class, keeping (117) illumination intensity at the current level, and
when if the brightness distribution spread (S) is in the wide class, controlling (117, 118, 119) illumination intensity depending on a number of bright objects in the image, further comprising determining the bright object threshold value (I1) as the brightness of the histogram bin having the lowest brightness of all histogram bins with a higher brightness than the most frequent brightness (I0), and having a size lower than the size (N0) of the histogram bin representing the most frequent brightness (I0) in the image, multiplied by a predefined ratio.

13. A monitoring device having a camera and an illuminating device and a computer configured to
determine (101, 402), via a computer, a brightness distribution of an image of the scene captured with the camera,
determine (103, 104, 106; 403), via the computer, a brightness distribution spread (S) and classify (112, 115; 404) the brightness distribution spread (S) into at least three classes, the at least three classes comprising a narrow class, a normal class, and a wide class, and
when the brightness distribution spread (S) is in the narrow class, increase (118) illumination intensity,
when the brightness distribution spread (S) is in the normal class, keep (117) illumination intensity at the current level, and
when if the brightness distribution spread (S) is in the wide class, control (117, 118, 119) illumination intensity depending on a number of bright objects in the image.

14. (canceled)

15. A non-transitory, computer-readable medium having stored thereon instructions that when executed by a computer cause the computer to control illumination intensity of a scene monitored by a camera, by:
determining (101, 402) a brightness distribution of an image of the scene captured with the camera,
determining (103, 104, 106; 403) a brightness distribution spread (S) and classifying (112, 115; 404) the brightness distribution spread (S) into at least three classes, the at least three classes comprising a narrow class, a normal class, and a wide class, and
when the brightness distribution spread (S) is in the narrow class, increasing (118) illumination intensity,
when the brightness distribution spread (S) is in the normal class, keeping (117) illumination intensity at the current level, and
when if the brightness distribution spread (S) is in the wide class, controlling (117, 118, 119) illumination intensity depending on a number of bright objects in the image.
